(19) United States
(12) Patent Application Publication
(10) Pub. No.: US 2025/0036739 A1
(43) Pub. Date: Jan. 30, 2025

(54) VIDEO QR CODE AUTHENTICATION

(71) Applicant: Bank of America Corporation, Charlotte, NC (US)

(72) Inventors: Elvis Nyamwange, Little Elm, TX (US); Sailesh Vezzu, Hilsborough, NJ (US); Amer Ali, Jersey City, NJ (US); Rahul Phadnis, Charlotte, NC (US); Rahul Yaksh, Austin, TX (US); Hari Vuppala, Charlotte, NC (US); Pratap Dande, Saint Johns, FL (US); Brian Jacobson, Los Angeles, CA (US); Erik Dahl, Newark, DE (US)

(21) Appl. No.: 18/226,332

(22) Filed: Jul. 26, 2023

(51) Int. Cl. G06F 21/36; G06F 21/62; G06K 7/14

(52) U.S. Cl. CPC G06F 21/36; G06F 21/6245; G06K 7/1417; G06F 2221/2141

(57) ABSTRACT

A video QR code may be used to authenticate a user using a user device. The video QR code may include a video in which a QR code is shown in motion over a time interval. The movement may be, for example, a change in position or orientation of the QR code. The authentication process may include generating the video QR code, causing a display of the video QR code, capturing, with the user device from the display, images of the QR code at specified times during the video, and determining whether there is a match between the captured images on the user device and the displayed images at the specified times. The authentication may also confirm the geolocation of the user device and the display match. The QR code may be extracted from the images. User access to a system may be granted upon verification of the QR code.

### FIELD OF THE DISCLOSURE

Aspects of the disclosure relate to using a video of a QR code in motion for enhanced user authentication.

### BACKGROUND OF THE DISCLOSURE

A quick response (QR) code is a two-dimensional matrix barcode that stores information as a unique pattern of squares and dots. A standard QR code is static in that it does not change. A QR code is typically used to access information embedded in the QR code itself. The accessed information may include a link (e.g., a URL (uniform resource locator)) to a web page to which one may be directed when the QR code is scanned.

Malicious actors have, at times, been able to copy legitimate static QR codes and use them illegitimately. For example, the QR codes may cause the codes to redirect users to other websites, such as websites that may have malicious content or phishing websites.

It would be desirable to have a QR code that can be used more securely than a static QR code, such as for user authentication.

### SUMMARY OF THE DISCLOSURE

It is an object of this invention to provide a more secure QR code that may be used for user authentication.

A system for electronically authenticating a user to access a computer system may be provided in accordance with the present disclosure. The system may include an authentication engine that may be configured to electronically authenticate the user. The system may include a video QR code generator engine that may be configured to generate a video QR code upon receipt of a request, by a user using a user device, for access to a computer system. The user device may include a camera. The system may include a video QR code analysis engine.

The video QR code may include a video. The video may include a QR code. The video may show a QR code in motion over a time interval. The movement may be dynamic in that the movement may be continuous over the time interval. In embodiments, the QR code in the video QR code may be unique to the system and may not be reused by the system for authentication.

The QR code that is selected for use in the video QR code may be selected randomly from available QR codes that have not been previously used for user authentication with the computer system. The random selection of the QR code may be performed using a random generator.

The authentication engine may include the video QR code generator engine. The authentication engine may generate the video QR code upon an authentication attempt by the user. The authentication engine may cause the video QR code to be played on a display of a second device. The authentication engine may obtain, from the user device, a plurality of images of the video QR code captured by the user device while the QR code is moving during the time interval that the video QR code is played on the display. The images may be captured in sequence within the video QR code.

The authentication engine may include the video QR code analysis engine. The video QR code analysis engine may determine whether the plurality of images of the video QR code that have been captured by the user device match user device match corresponding images in the video QR code that were displayed when the plurality of images were captured. The authentication engine may authenticate the user upon verifying, using the video QR code analysis engine, that the QR code in multiple images of the plurality of images matches the QR code in the generated video QR code before providing the user with the requested access to the computer system.

The movement of the QR code in the video QR code may include a change in one or more of a position or an orientation of the QR code. The movement of the video QR code may include a rotation of the QR code from a first angular orientation to a second angular orientation.

The authentication engine may be configured to verify a geographic location of the user based on a detected location of the user device that captures the plurality of images of the video QR code and a location of the display. The authentication engine may be configured to instruct the user device when to capture the plurality of images.

The video QR code may include time stamp information, such as one or more time stamps. The authentication engine may be configured to instruct the user device to capture the plurality of images at specific times while the video QR code is played on the display based on the time stamp information in the video QR code.

The plurality of images obtained from the user device may include the video QR code in its entirety. The plurality of images obtained from the user device may include select images from the video QR code.

An application may be resident on the user device and may be configured for the user to request access to the computer system and to capture the plurality of images of the video QR code. The application may include a mobile banking application. The computer system may include a banking system.

An electronic authentication computer program product comprising executable instructions may be provided in accordance with the present disclosure. The executable instructions, when executed by a processor on a first computer system may receive an electronic authentication request from a user device. The executable instructions may generate, in response to the electronic authentication request, a video QR code that is configured to electronically authenticate the user before providing access by the user to a second computer system. The video QR code may include a video. The video may include a QR code. The video QR code may include a video that shows a QR code in motion over a time interval. The executable instructions may obtain, from the user device, a plurality of images of the video QR code captured by the user device while the QR code is moving during the time interval that the video QR code is played on the display. The executable instructions may determine whether the plurality of images of the video QR code that have been captured by the user device match corresponding images in the video QR code that were displayed when the plurality of images were captured. The executable instructions may authenticate the user upon verifying that the QR code in multiple images of the plurality of images matches the QR code in the generated video QR code before providing the user with the requested access.

The movement of the QR code in the video QR code may include a change in one or more of a position or an orientation of the QR code. The movement of the video QR code may include a rotation of the video QR code from a first angular orientation to a second angular orientation.

The executable instructions may verify a geographic location of the user based on a detected location of the user device that captures the plurality of images of the video QR code and a location of the display. The executable instructions may instruct the user device when to capture the plurality of images.

The video QR code may include time stamp information. The executable instructions may instruct the user device to capture the plurality of images at specific times or time intervals while the video QR code is played on the display. The capture of the images may be based on the time stamp information in the video QR code.

The executable instructions may confirm a geographic location of the user based on a detected location of the user device that captures the plurality of images of the video QR code and a location of the display. The executable instructions may instruct the user device when to capture the plurality of images captured.

A method for performing authentication of a user using a video QR code may be provided in accordance with the present disclosure. The method may include receiving an electronic authentication request from a user device. The method may include generating, in response to the electronic authentication request, a video QR code that is configured to electronically authenticate the user before providing access by the user to a second computer system. The video QR code may include a video that shows a QR code in motion over a time interval. The method may include obtaining, from the user device, a plurality of images of the video QR code captured by the user device while the QR code is moving during the time interval that the video QR code is played on the display. The method may include determining whether the plurality of images of the video QR code that have been captured by the user device match corresponding images in the video QR code that were displayed when the plurality of images were captured. The method may include authenticating the user upon verifying that the QR code in multiple images of the plurality of images matches the QR code in the generated video QR code before providing the user with the requested access. The method may include confirming a geographic location of the user based on a detected location of the user device that captures the plurality of images of the video QR code and a location of the display.

The user device may include a mobile banking app for the user to request authentication. The user device may perform the scan of the video QR code to authenticate the user to perform mobile banking.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative system architecture in accordance with principles of the disclosure.

FIG. 2 shows an illustrative apparatus of a device in accordance with principles of the disclosure.

FIG. 3 shows an illustrative system for user authentication using a video QR code in accordance with principles of the disclosure.

FIG. 4A shows a first illustrative image in a video QR code in which the QR code is positioned a first orientation in accordance with the present disclosure.

FIG. 4B shows a second illustrative image in a video QR code in which the QR code is positioned in a second orientation in accordance with the present disclosure.

FIG. 4C shows a third illustrative image in a video QR code in which the QR code is positioned in a third orientation in accordance with the present disclosure.

FIG. 5 shows an illustrative example of a flow chart for performing a method for user authentication using a video QR code in accordance with principles of the present disclosure.

FIG. 6 shows an illustrative system in accordance with principles of the disclosure.

### DETAILED DESCRIPTION OF THE DISCLOSURE

The present disclosure relates to computer program products, methods, and apparatus for more secure authentication of a user using a video QR code.

The present disclosure describes an authentication computer program product, system and method that uses a video QR code for automated user authentication. The authentication may enable a user to login to a system. The system may be any type of computer system which is secured and to which the user seeks access. For example, the system may be a banking computer system that belongs to a financial institution at which a user may maintain a bank account. Or the system may be any type of system that requires user authentication. The authentication may be used for other purposes, such as to permit data on a device that is authenticated to be decrypted. The authentication may be a part of a multi-factor authentication (MFA) in which a user may also perform some other type of authentication, such as a password authentication in addition to an authentication with a video QR code. The entry of a password may trigger the attempt at an authentication with the video QR code. In embodiments, the authentication of the video QR code may be the only authentication required.

As used herein, a video QR code is a video of a QR code that is configured to display the QR code in motion while the video is played. The QR code that is used may be randomly selected from available QR codes, such as available QR codes that have not been previously used for user authentication with the computer system. The random selection of the QR code may be performed using a random generator.

When the video is played, the QR code may be seen on an electronic display as moving over a time interval while playing the video. The movement may include, for example, movement in one or more of a change in position, orientation, or both, on a display over a time interval. The time interval may be, for example, a few seconds, such as 5 seconds or 10 seconds, or during some other shorter or longer time interval. In embodiments, the movement of the QR code may be continuous during the video. In other embodiments, the movement of the QR code may be discontinuous so that, at one or more times, the movement stops and then resumes during the video. The video QR code may include a video of a series of images of the QR code in which the QR code may be displayed in different positions or orientations. The images may include still snapshots or video segments. The video of the QR code may include time information that may be used to identify locations of images in the video. The video QR code may be scanned, such as with a camera to capture images. Time information may include time stamps inserted at intervals of the video. In addition, a time may be included in the QR code, which time may indicate, for example, a time at which the QR code was created. The time stamps may be used to confirm geolocations (geographic locations). The time stamps may be used to time when views on a display are to be captured as images for use in authentication and to provide a time at which images in the video QR code that was generated are to be compared to the images captured from the display.

In embodiments, the video QR code may include more than one QR code within the video.

The video QR code may be generated by a video QR code generator engine that creates a unique QR code that may be used in the video QR code for authentication. The QR code may be a QR code that is unique to user authentication for the system to which access is requested. The QR code may be unique in that the QR code may not be used again for authenticating this user or any other user trying to access the computer system. The video QR code generator engine may itself be monitored for any compromise in security.

The video QR code generator engine may generate the video QR code by creating a video of a QR code in motion, such as changing position or orientation, or by generating instructions for the QR code to move over a time interval. The video QR code may show, on a display, the QR code in motion during the time interval. The movement of the video QR code may be changed using a randomizer so that there is no regular pattern of movement. The movement of the video QR code may be dynamic in that the QR code may be shown in continuous motion. The movement of the QR code may be discontinuous so that the QR code does not move at some times in the video. The video QR code may show each movement only once during the video or may repeat the same movements multiple times. The uniqueness of each QR code that is used for authentication may be preserved by retaining a record of QR codes that have been previously generated as video QR codes and not reusing QR codes that have been previously generated. A newly generated QR code may be added to the list of QR codes that have already been used.

The video QR code may be used, in operation, to authenticate a user. The authentication may be part of a login. The user login may include entering a user identification (user ID). The user login may require entry of a password. The user login may require authentication using a video QR code. The login may be attempted from a user device. The user device may be, for example, a computer or a mobile device, such as a mobile phone, laptop, tablet or other mobile device. The user device may have a camera. The login may be made using an application that may be loaded on the user device. The application may be configured to access a system. The application may be a banking application, such as a mobile banking application. The application may be configured to scan a video QR code using a camera on the user device and capture one or more images from a video QR code at specified times during the playing of the video. The images may be captured at pre-set intervals, such as at evenly spaced intervals or at instances determined by the application or by a backend network. Authentication engine at the backend network may be implemented in the application layer of the network.

The application may transmit the captured images of the video QR code to the backend network for processing. The backend network may authenticate the user by validating the captured images. The validation may include verifying that the captured images at certain times match the same images in the video QR code. The match may include a match of the position and orientation of the captured images to the video QR code as generated. A common geolocation of the user device and the displayed may also be checked. The system to be accessed may then determine whether to permit user access to the system. The captured images may be transmitted in encrypted form and then decrypted upon receipt at backend network.

Illustrative embodiments of methods, systems, and apparatus in accordance with the principles of the invention will now be described with reference to the accompanying drawings, which form a part hereof. It is to be understood that other embodiments may be used, and structural, functional, and procedural modifications may be made without departing from the scope and spirit of the present invention.

The drawings show illustrative features of methods, systems, and apparatus in accordance with the principles of the invention. The features are illustrated in the context of selected embodiments. It will be understood that features shown in connection with one of the embodiments may be practiced in accordance with the principles of the invention along with features shown in connection with another of the embodiments.

The methods, apparatus, computer program products, and systems described herein are illustrative and may involve some or all the steps of the illustrative methods and/or some or all of the features of the illustrative system or apparatus. The steps of the methods may be performed in an order other than the order shown or described herein. Some embodiments may omit steps shown or described in connection with the illustrative methods. Some embodiments may include steps that are not shown or described in connection with the illustrative methods, but rather are shown or described in a different portion of the specification.

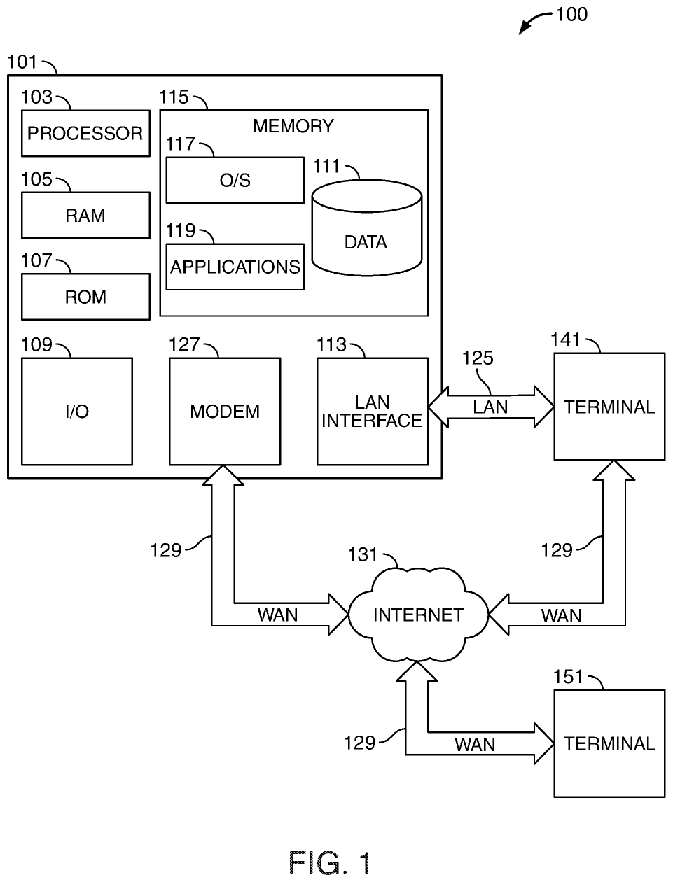

FIG. 1 shows an illustrative block diagram of system 100 that includes computer 101. Computer 101 may alternatively be referred to herein as an “engine,” “server” or a “computing device.” Computer 101 may be any computing device described herein, such as the computing devices running on a computer, smart phones, smart cars, smart cards, and any other mobile device described herein. Elements of system 100, including computer 101, may be used to implement various aspects of the systems and methods disclosed herein.

Computer 101 may have a processor 103 for controlling the operation of the device and its associated components, and may include RAM 105, ROM 107, input/output circuit 109, and a non-transitory or non-volatile memory 115. Machine-readable memory may be configured to store information in machine-readable data structures. Other components commonly used for computers, such as EEPROM or Flash memory or any other suitable components, may also be part of the computer 101.

Memory 115 may be comprised of any suitable permanent storage technology—e.g., a hard drive. Memory 115 may store software including the operating system 117 and application(s) 119 along with any data 111 needed for the operation of computer 101. Memory 115 may also store videos, text, and/or audio assistance files. The data stored in Memory 115 may also be stored in cache memory, or any other suitable memory.

Input/output (“I/O”) module 109 may include connectivity to a microphone, keyboard, touch screen, mouse, and/or stylus through which input may be provided into computer 101. The input may include input relating to cursor movement. The input/output module may also include one or more speakers for providing audio output and a video display device for providing textual, audio, audiovisual, and/or graphical output. The input and output may be related to computer application functionality.

Computer 101 may be connected to other systems via a local area network (LAN) interface 113. Computer 101 may operate in a networked environment supporting connections to one or more remote computers, such as terminals 141 and 151. Terminals 141 and 151 may be personal computers or servers that include many or all the elements described above relative to computer 101.

In some embodiments, computer 101 and/or Terminals 141 and 151 may be any of mobile devices that may be in electronic communication with consumer device 106 via LAN, WAN, or any other suitable short-range communication when a network connection may not be established.

When used in a LAN networking environment, computer 101 is connected to LAN 125 through a LAN interface 113 or an adapter. When used in a WAN networking environment, computer 101 may include a communications device, such as modem 127 or other means, for establishing communications over WAN 129, such as Internet 131.

In some embodiments, computer 101 may be connected to one or more other systems via a short-range communication network (not shown). In these embodiments, computer 101 may communicate with one or more other terminals 141 and 151, such as the mobile devices described herein etc., using a personal area network (PAN) such as Bluetooth®, NFC (Near Field Communication), ZigBee, or any other suitable personal area network.

It will be appreciated that the network connections shown are illustrative and other means of establishing a communications link between computers may be used. The existence of various well-known protocols such as TCP/IP, Ethernet, NFT, HTTP, and the like is presumed, and the system can be operated in a client-server configuration to permit retrieval of data from a web-based server or API (Application Programming Interface). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may be to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking functionality related to performing various tasks. Application programs 119 may use one or more algorithms that process received executable instructions, perform power management routines or other suitable tasks.

Application program(s) 119 may include computer executable instructions (alternatively referred to as “programs”). The computer executable instructions may be embodied in hardware or firmware (not shown). The computer 101 may execute the instructions embodied by the application program(s) 119 to perform various functions.

Application program(s) 119 may use the computer-executable instructions executed by a processor. Generally, programs include routines, programs, objects, components, data structures, etc. that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage, and process data (e.g., “cloud computing” and/or “fog computing”).

One or more of applications 119 may include one or more algorithms that may be used to implement features of the disclosure.

The invention may be described in the context of computer-executable instructions, such as applications 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 101 and/or terminals 141 and 151 may also include various other components, such as a battery, speaker, and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 151 and/or terminal 141 may be portable devices such as a laptop, cell phone, Blackberry™, tablet, smartphone, or any other computing system for receiving, storing, transmitting and/or displaying relevant information. Terminal 151 and/or terminal 141 may be one or more user devices. Terminals 151 and 141 may be identical to computer 101 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, and/or smartphones, multiprocessor systems, microprocessor-based systems, cloud-based systems, programmable consumer electronics, network PCs, minicomputers, mainframe computers, distributed computing environments that include any of the above systems or devices, and the like.

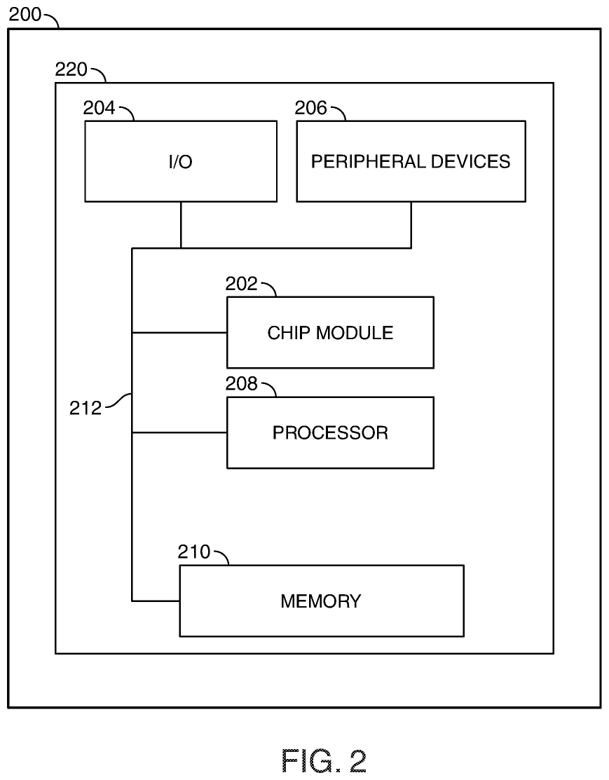

FIG. 2 shows illustrative apparatus 200, which may be a computing device. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 219, signals, and/or any other suitable information or data structures.

Components 202, 204, 206, 208 and 210 may be coupled together by a system bus or other interconnections 212 and may be present on one or more circuit boards such as circuit board 220. In some embodiments, the components may be integrated into a single chip. The chip may be silicon-based.

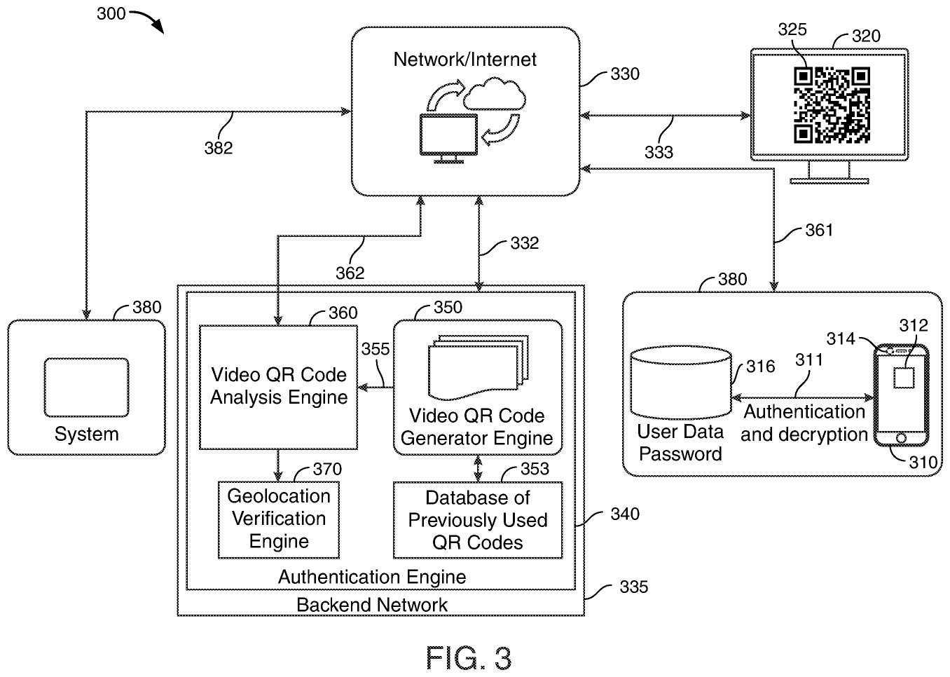

FIG. 3 shows an illustrative system 300 for performing user authentication using a video QR code. System 300 may be used to authenticate the user to access a computer system 380. A user device 310 may be an electronic device, such as computer, a mobile phone, a laptop, or a tablet. User device 310 may be a smartphone. User device 310 may have an application 312 loaded thereon to access computer system 380 via network 330, such as over links 361 and 382. User device 310 may also include one or more cameras 314 on the back of the user device 310. Computer system 380 may be any type of computer system. For example, computer system 380 may be an online banking system. Some communications between elements in system 300 may be performed over a network or the Internet 330. System 300 may also use a display 320 that may be a standalone display or a display on or in communication with another user device (not shown) other than user device 310.

A user may open application 312 and may attempt to log in to computer system 380. The login may include entering user data, such as a user ID. The user ID may include a password. The user data may be verified with reference to a database 316 of user data. A non-password authentication may be required to log in. This authentication may be in addition to or instead of a password. Application 312 may also be configured to cause a display of a video QR code on a screen of another device or display and to read the resulting video QR code once it is displayed on the screen of the other device or display.

A backend network 335 of system 300 may include components, such as a server and a database 353. Backend network 335 may include one or more software engines that may be used to perform the authentication. An authentication engine 340 and three engines (sub-engines) 350, 360, 370 are shown in FIG. 3. However, the functions of backend network 335 may be distributed across fewer or more engines. The backend network 335 may be operated by the provider of the application or the system operator, which may be the same entity, or may be operated by a third party.

A video QR code generator engine 350 may be used to generate video QR codes. The QR code used in authentication engine 340 may be generated elsewhere and obtained by authentication engine 340 or may be generated by authentication engine 340. The QR code may be unique to the QR codes used for authentication in that no QR codes may be duplicated for use with system 380. Video QR code generator engine 350 may generate a video showing the QR code, such as video QR code 325, in motion. The video may vary in length. The video may be, for example, 5 or 10 second long. The video QR code may be transmitted to display 320 for playing the video QR code, including a display of the QR code in motion. A database 353 at the backend network 335 may maintain a record of QR codes that have been previously used to prevent a duplicate QR code from being used for a different authentication process. The newly generated QR code that is used in the video QR code may be added to database 353 once generated.

User device 310 or another user device in communication with system 300 may scan the video QR code from display 320. An application, such as application 312, on user device 310 may be configured to capture images of the video QR code at different times during the video. The times at which the images are captured may be specified by an authentication engine 340 on a backend network or by application 312. Specific images may be captured using camera 314 on user device 310, or user device 310 may capture images of the entire video.

Application 312 on user device 310 may control when the playing of video QR code on display 320 begins. Time stamps may be encoded into the video QR code to synchronize the images that are captured by application 312 during the playing of the video QR code. The captured images may be transmitted over links 361 and 362 from user device 310 to authentication engine 340 at a backend network 335 for analysis.

A video QR Code Analysis Engine 360 at authentication engine 340 may be used to determine whether the images that were captured at specified times while playing of the video match. The match may include a match in the position and orientation of the QR code as well as other elements of the image including the QR code itself. The analysis may include extracting features of the captured images. A successful match may require that all captured images be verified against the images as they appear in the video QR code. In embodiments, a successful match may only require that fewer than all images be verified. Upon matching of the images, the QR codes may be extracted from the images and validated. The validation may include aligning the QR codes in the captured images to confirm that the QR code matches the QR code in the generated video QR code. (If multiple QR codes were used during the video, then a match may be made according to the multiple QR codes.)

Authentication engine 340 may also include a geolocation verification engine 370 that may verify that user device 310 is near display 320.

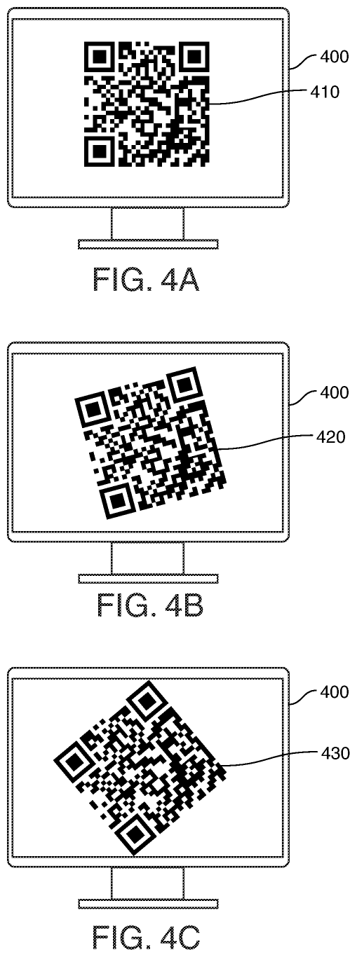

As noted above, a video QR code 325 may be displayed on a display 320. Video QR code 325 may be displayed as moving in time during a time interval. FIGS. 4A, 4B, and 4C illustrate one example of a movement of an image of a QR code while playing of a video QR code on a display 400. The movement may include a change in orientation of the QR code during the video.

FIG. 4A shows an illustrative image 410 of a video QR code in a first orientation in which the QR code may be displayed on display 400 in an upright orientation. Image 410 shown in FIG. 4A may be, for example, an initial orientation of the video QR code at the beginning of the video.

FIG. 4B shows an illustrative image 420 of the video QR code displayed on display 400 in a second orientation rotated several degrees counterclockwise from the orientation shown in FIG. 4A. This second orientation may be, for example, an orientation of the video QR code while the QR code is moving during the playing of the video.

FIG. 4C shows an illustrative image 430 of the video QR code displayed on display 400 in a third orientation rotated additional degrees counterclockwise from the second orientation shown in FIG. 4B. Apart from the changes in orientation, the position of the QR code in the illustrated example of FIGS. 4A, 4B, and 4C may remain the same. To capture the different orientations of the QR code as intended, a user device may need to capture each of the images with the same orientation of the camera on the user device. This may be achieved by holding the user device steady in the same position during a scan of the video QR code.

In embodiments, the movement of the QR code in the video QR code may change in position on the display. The user device may be able to capture a larger area of the display so that the positional movement of the QR code may be detected.

In an illustrative operation of system 300, a user may attempt a login to a computer system 380 using application 312 on user device 310. The application 312 may be a mobile banking application that may be used to access an account at a financial institution or may be some other type of application used to access a different type of system. The user may be prompted to authenticate the user as part of the login process. The authentication that may be used may be an authentication that uses a video QR code. The authentication may be a single factor authentication or a multi-factor authentication (MFA).

The login request by the user may be transmitted to an authentication engine 340 at backend network 335. The request may be transmitted over a network 330, such as the Internet, and links 361 and 332. A video QR Code Generator Engine 350, which may be included in authentication 340 or in communication with authentication 340, may generate a video QR code in response to the user request to be authenticated.

Engine 350 may be configured to first generate the QR code that is to be used in the video QR code by itself or may obtain the QR code from a separate QR code engine (not shown). Where used, QR code engine may be operated by the same entity as backend network 335 or may be operated by a third party. User information may be encoded into the QR code. The user information may include data, such as username, a current password, and a current timestamp. The user information may be converted into hexadecimal numbers using algorithms, and the hexadecimal data may be encrypted, such as with an RSA algorithm, and may be encoded to base 64. The user data may be processed by QR code video generator to be included with the video QR code. The video QR code may be encrypted for increased security during transmission.

The video QR code may be transmitted, such as over network 330 via link 333, to display 320 for playing of a video QR code 325. The video QR code may be displayed as multiple images on display 320. One illustrative image of the multiple images in the video QR code 325 is shown on display 320 in FIG. 3.

User device 310 may be used to scan the video QR code 325 with camera 314 during the playing of the video QR code. User device 310 may capture images, such as snapshots, during the scan of the video QR code.

The images captured by user device 310 may be transmitted to authentication engine 340 at backend network 335. Video QR Code Analysis Engine 360 at authentication engine 340 may receive the captured images and analyze them to verify whether the images that are captured match corresponding images in the video QR code.

The captured images may be maintained, as is, without aligning the QR code using a code alignment pattern that may otherwise automatically realign each image of the QR code to be identically positioned or oriented. The captured images may be processed relative to one another to determine whether there is a match between the captured images and the video QR code. The camera may be maintained by the user in a relatively fixed position so that any changes in the positions of the QR code are accurately captured.

Corresponding images may be images in the video QR code that are located at the times within the video at which the images were captured. For example, images may be captured by user device 310 at 0 seconds, 1 second, 2 seconds, 3 seconds, 4 seconds, and 5 seconds relative to the start of the video during a 5 second video QR code. These images may be captured based on times specified in application 312 at user device 310. These times may be specified to application 312 by authentication engine 340.

The Video QR Code Analysis Engine 360 may obtain the original video QR code from the Video QR Code Generator Engine 350, such as over link 355. Video QR Code Analysis Engine 360 may perform feature extraction from the captured images. The extracted features may be compared to features in the video QR code that was generated for display. The match may require a match of features for captured images.

As an example, a video QR code may have a duration of 5 seconds. The video QR code may be scanned so that a snapshot of the video QR code may be taken at a regular interval, such as at each second. Where images of the video QR codes were captured at 0, 1, 2, 3, 4 and 5seconds, some or all of the captured images may be compared to the same images in the originally generated video QR codes at 0, 1, 2, 3, 4, or 5 seconds from the start of the original video QR code. A match may only be required for fewer than all of the images. This may allow for the possibility that one or more of the snapshots of the scanned video QR code may have been blurry or data for one or more snapshots may have been corrupted. If there is no match, the authentication process may terminate, and the user may be offered another opportunity to authenticate.

If there is a match between the generated video QR code and all of the images of the video QR code for which a match is required, Video QR Code Analysis Engine 360 may extract the QR code from the captured images and may attempt to validate the QR code in the video QR code to confirm that it matches the original QR code that was included in the video QR code. The validation of the QR code may include the validation of the time stamp that may be encoded into QR code, where the time stamp may reflect the time that the QR code was generated.

Upon authentication, the system may determine whether the user may be granted access to the system upon successful completion of the authentication. A determination may be made by checking access rules defined by authentication engine 340.

For increased security during authentication, or after authentication but before system access is provided, the authentication application may also perform a geolocation verification of the user device 310. The location of the user device that scanned the video QR code may be checked, such as by using Global Positioning System (GPS) coordinates of user device 310 or in some other manner, to confirm that user device 310 is near the geolocation of display 320 at which the video QR code was displayed. The geolocation of display 320 may also be known, such as by use of GPS, an IP address with which display 320 is associated, or in some other manner. If the geolocation of display 320 matches the geolocation of user device 310, as user device 310 is within a specified proximity of display 320, the application may conclude that user device 310 is legitimate and has not been hacked or hijacked. If the authentication is successful, the user may be granted access to system 380. However, if the user device is not near the display, this may indicate that the user trying to get authenticated is not legitimate and access may be denied. The user may retry to be authenticated if the first attempted authentication is denied.

Using a video QR code may prevent hacking of the QR code as compared to a static QR code that does not move. Hackers may be able to hack a static QR code cause an undesirable result. A video QR code that displays a moving QR code, which motion may be randomized, offers authentication with much improved security as it would be difficult to clone a video QR code.

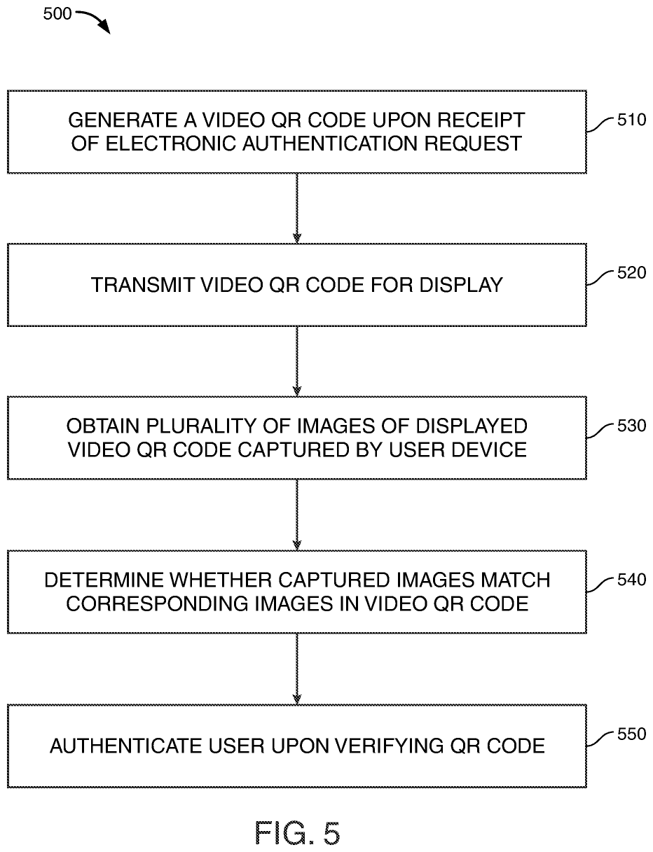

FIG. 5 shows an illustrative example of a flow chart 500 for authenticating a user using a video QR code. At step 510, a video QR code may be generated upon receipt of an electronic authentication request from a user using a user device. At step 520, a video QR code may be transmitted for display. The display may include playing the video QR code. At step 530, a plurality of images of the video QR code that may be caused to be displayed and may be captured by the user device. At step 540, the captured images may be compared to the video QR code that was generated to check for a match of the captured images to corresponding images within the video QR code. At step 550, the QR code(s) in the images may be validated to confirm that the QR code or codes are the codes that were included in the video QR code. If there is a match, authentication may be successful. The geolocations of the user device and display may also be verified. Upon authenticating a user, system 380 may determine whether to grant the user access to system 380.

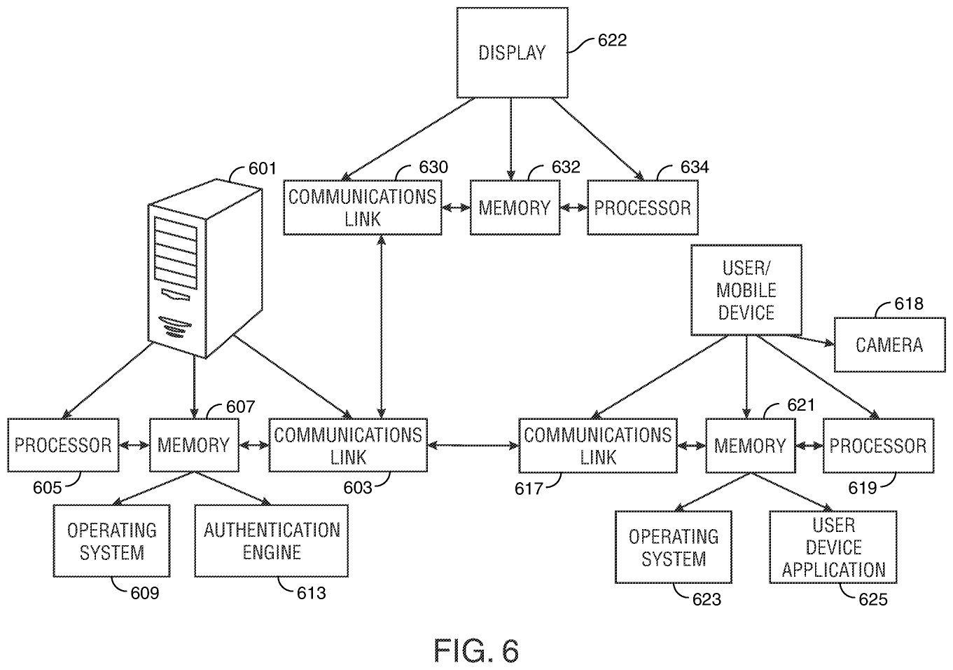

FIG. 6 shows an illustrative system in accordance with principles of the disclosure. The system may include a central server 601, a user device 516, such as a mobile device, and a display 622.

Central server 601 may include a server communications link 603, a server processor/processors 605, and a server non-transitory memory 607, as well as other components.

User device 616 may include a non-transitory memory 621, a user device communications link 617, a processor 619, and a camera 618, as well as other components.

Display 622 may include a communications link 630, a non-transitory memory 632, and a processor 634. Display 622 may be a screen on a computer or other user device.

The server non-transitory memory 607 may include a server operating system 609, and an authentication engine 613 for authenticating a user, as well as other data and programs. Authentication engine 613 may be used to authenticate a user using a video QR code. Authentication engine 613 may
obtain, from a video QR code generator engine, which may be included within authentication engine 613 or elsewhere, a video QR code upon an authentication attempt by a user;
cause the video QR code to be displayed on the display 622;
obtain, from the user device 616, a plurality of images of the video QR code captured by the user device while the QR code is moving during the time interval that the video QR code is played on the display 622; and
determine whether the plurality of images of the video QR code that have been captured by the user device match the video QR code that is caused to be displayed; and
authenticate the user upon verifying, using a video QR code analysis engine which may be included within automated authentication engine 613 or elsewhere, that the QR code in multiple images of the plurality of images matches the QR code in the generated video QR code before providing the user with the requested access to the computer system.

The server communications link 603 may communicate with a user device, such as mobile device 616 (as well as other servers/computers, not shown), through communications link 617. The server communications link 603 may communicate with display 622 through (as well as other servers/computers, not shown) the communications link 630.

By using this system, computer program product, and method, a QR code may be used to securely authenticate a user who requests access to a computer system.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, methods, systems, apparatuses, and computer program products may implement secure authentication using a QR code. Persons skilled in the art will appreciate that the present invention can be practiced by other than the described embodiments, which are presented for purposes of illustration rather than of limitation.

What is claimed is:

1. A system for electronically authenticating a user, the system comprising:
an authentication engine comprising:
a video QR code generator engine configured to generate a video QR code upon receipt of a request, by a user using a user device, for access to a computer system, wherein the video QR code comprises a video that shows a QR code in motion over a time interval; and
a video QR code analysis engine;
wherein the authentication engine is configured to electronically authenticate the user by:
obtaining, from the video QR code generator engine, the video QR code upon an authentication attempt by the user;
causing the video QR code to be played as a moving QR code on a display of a second device;
obtaining, from the user device, a plurality of images of the video QR code captured by the user device while the QR code is moving during the time interval that the video QR code is played on the display; and
determining, using the video QR code analysis engine, whether the plurality of images of the video QR code that have been captured by the user device match corresponding images in the video QR code that were displayed when the plurality of images were displayed; and
authenticating the user upon verifying, using the video QR code analysis engine, that the QR code in multiple images of the plurality of images matches the QR code in the video QR code before providing the user with access to the computer system.

2. The system of claim 1, wherein movement of the QR code in the video QR code comprises a change in one or more of a position or an orientation of the QR code.

3. The system of claim 1, wherein movement of the video QR code includes a rotation of the QR code in the video QR code from a first angular orientation to a second angular orientation.

4. The system of claim 1, wherein the authentication engine is further configured to verify a geographic location of the user based on a detected location of the user device that captures the plurality of images of the video QR code and a location of the display.

5. The system of claim 1, wherein the authentication engine is further configured to instruct the user device when to capture the plurality of images captured by the user device.

6. The system of claim 1, wherein
the video QR code further includes time stamp information; and
the authentication engine is configured to instruct the user device to capture the plurality of images at specific times while the video QR code is played on the display based on the time stamp information in the video QR code.

7. The system of claim 1, wherein the plurality of images obtained from the user device comprise the video QR code in its entirety.

8. The system of claim 1, wherein the plurality of images obtained from the user device comprise select images from the video QR code.

9. The system of claim 1, further comprising an application, resident on the user device, that is configured for the user to request access to the computer system and to capture the plurality of images of the video QR code.

10. The system of claim 9, wherein the application comprises a mobile banking application, and the computer system comprises a banking system.

11. An electronic authentication computer program product comprising executable instructions that, when executed by a processor on a first computer system:
receive a request from a user using a user device to access a second computer system;
generate, in response to the request, a video QR code, wherein the video QR code comprises a video that shows a QR code in motion over a time interval;
obtain, from the user device, a plurality of images of the video QR code captured by the user device while the QR code is moving during the time interval that the video QR code is played on a display;
determine whether the plurality of images of the video QR code that have been captured by the user device match corresponding images in the video QR code that were displayed when the plurality of images were captured; and
authenticate the user upon verifying that the QR code in multiple images of the plurality of images matches the QR code in the video QR code before providing the user with the requested access to the second computer system.

12. The computer program product of claim 11, wherein movement of the QR code in the video QR code comprises a change in one or more of a position or an orientation of the QR code.

13. The computer program product of claim 11, wherein movement of the video QR code includes a rotation of the QR code in the video QR code from a first angular orientation to a second angular orientation.

14. The computer program product of claim 11, wherein the executable instructions further verify a geographic location of the user based on a detected location of the user device that captures the plurality of images of the video QR code and a location of the display.

15. The computer program product of claim 11, wherein the executable instructions further instruct the user device when to capture the plurality of images captured by the user device.

16. The computer program product of claim 11, wherein
the video QR code further includes time stamp information; and
the executable instructions further instruct the user device to capture the plurality of images at specific times while the video QR code is played on the display based on the time stamp information in the video QR code.

17. The computer program product of claim 11, wherein the executable instructions further confirm a geographic location of the user based on a detected location of the user device that captures the plurality of images of the video QR code and a location of the display.

18. The computer program product of claim 11, wherein the executable instructions further instruct the user device when to capture the plurality of images captured by the user device.

19. A method for performing authentication of a user, the method comprising:
receiving an electronic authentication request from a user device;
generating, in response to the electronic authentication request, a video QR code that is configured to electronically authenticate the user before provide access by the user to a computer system, wherein the video QR code comprises a video that shows a QR code in motion over a time interval;
obtaining, from the user device, a plurality of images of the video QR code captured by the user device while the QR code is moving during the time interval that the video QR code is played on a display;
determining whether the plurality of images of the video QR code that have been captured by the user device match corresponding images in the video QR code that were displayed when the plurality of images were captured; and
authenticating the user, upon verifying that the QR code in multiple images of the plurality of images matches the QR code in the video QR code, before providing the user with the requested access.

20. The method of claim 19, further comprising:
confirming a geographic location of the user based on a detected location of the user device that captures the plurality of images of the video QR code and a location of the display.
